(19) United States
(12) Patent Application Publication
(10) Pub. No.: US 2026/0245543 A1
(43) Pub. Date: Aug. 20, 2026

(54) HYBRID TEXT TO SPEECH

(71) Applicant: Microsoft Technology Licensing, LLC, Redmond, WA (US)

(72) Inventors: Jinzhu LI, Beijing (CN); Guangyu WU, Beijing (CN); Yulin LI, Beijing (CN); Yinhe WEI, Beijing (CN); Sheng ZHAO, Beijing (CN); Kuan CHEN, Beijing (CN)

(21) Appl. No.: 18/040,142

(22) PCT Filed: Apr. 26, 2021
(86) PCT No.: PCT/CN2021/089825

§ 371 Date: Jan. 31, 2023

(51) Int. Cl. G10L 13/08; G10L 13/047

(52) U.S. Cl. CPC G10L 13/08; G10L 13/047

(57) ABSTRACT

A system and method for a hybrid text to speech (TTS) system that receives textual data from a user application; determines that the received textual data is missing from the cache; sends the received textual data to both a remote TTS engine and to a TTS engine in the device; receives speech data from both the remote TTS engine and the TTS engine in the device; and selects or combines, based on a selection policy, the speech data from the remote TTS engine or the TTS engine in the device. The speech data is transmitted to the user application.

### BACKGROUND

Text to speech (TTS) is used in many scenarios, including modern vehicles and Internet of Things (IoT) devices. TTS applications use both online TTS systems and offline, or local, TTS systems, each of which have advantages and disadvantages. Online TTS systems can be of a higher quality and are easier to update, but require a network connection to function. Offline TTS systems can function without a network connection but may be of a relatively lower quality and are more difficult to update. Hybrid TTS systems use both online TTS systems and offline TTS systems, where online TTS systems are used when available and offline TTS systems are used as a secondary option. However, these hybrid systems face challenges in providing a seamless, consistent user experience, efficient computing resource management, and a user development effort to design and implement a robust mixed online-offline system. For example, the transitions between the online and offline TTS systems are often distracting, prone to delay, and having inconsistent quality.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A method for a hybrid text to speech software development kit is described. The method includes receiving textual data from a user application; determine that the received textual data is not stored in a cache; sending the received textual data to a remote text to speech (TTS) engine and a TTS engine in a device, receiving speech data from both the remote TTS engine and the TTS engine in the device; selecting, based on a selection policy, the speech data from the remote TTS engine, the TTS engine in the device, or both, and transmitting the selected speech data to a user application.

### BRIEF DESCRIPTION OF THE DRAWINGS

The present description will be better understood from the following detailed description read in light of the accompanying drawings, wherein:

FIG. 1 is a block diagram illustrating a system for hybrid text to speech (TTS) architecture according to an embodiment;

FIG. 2 is a block diagram illustrating a system for a hybrid TTS system according to an embodiment;

FIGS. 3A and 3B are sequence diagrams illustrating a computerized method for a hybrid TTS system according to an embodiment;

FIG. 4 is a flowchart illustrating a computerized method for selecting speech data from one or more of a remote TTS or a local TTS according to an embodiment;

FIG. 5 is a flowchart illustrating a computerized method for operating a cache according to an embodiment;

FIG. 6 is a flowchart illustrating a computerized method for a hybrid TTS system according to an embodiment; and

FIG. 7 illustrates a computing apparatus according to an embodiment as a functional block diagram.

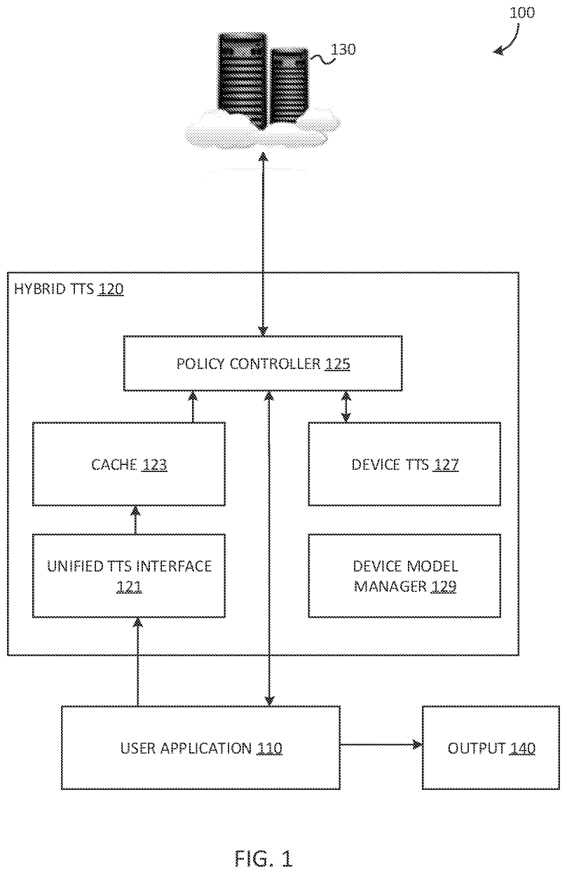

Corresponding reference characters indicate corresponding parts throughout the drawings. In FIGS. 1 to 7, the systems are illustrated as schematic drawings. The drawings may not be to scale.

### DETAILED DESCRIPTION

Aspects of the disclosure provide a computerized method and system for a hybrid text to speech (TTS) architecture that utilizes online TTS and local device TTS in parallel to provide a seamless user experience. Online (e.g., cloud, cloud-based, remote, or off-device) TTS systems can provide higher resolution and quality than offline (e.g., device, device-based, on-device, or local) TTS systems, but are not always available due to network connection requirements. Due to various reasons including unstable network connections, the lack of a network connection, and so forth, applications are conventionally provided to manage the handoff between remote TTS and local TTS systems. A conventional application includes separate mechanisms for remote TTS handling that interact with a remote TTS application programming interface (API) and for local device TTS handling that interact with a local device TTS. In these platforms, significant strain is placed on the application due to the overwhelming amount of processing that is performed on the application itself. Furthermore, managing separate TTS systems for the remote TTS and the local TTS leads to inefficiencies due to the latency introduced when the application is forced to switch from executing the remote TTS system to executing the local TTS due to a dropped network connection.

Accordingly, the system provided in the present disclosure operates in an unconventional manner by providing a unified TTS interface, exposed to user applications, that communicates with both remote TTS systems and local TTS systems. Using the TTS interface reduces the computational resource complexity, such as how the network status is managed, the device status is managed, the coding and development effort to reduce complexity, and so forth in order to increase the robustness of the system. Robust handling with the network and complex logic requires significant effort to produce a quality design, coding, and testing. The TTS interface provided herein enables users to avoid this effort while maintaining the robustness of the system. The unified TTS interface provided in the present disclosure communicates with one or more user applications that are separate from each of the remote TTS system and the local TTS system, which reduces processing requirements for the user-facing user applications. A policy controller is provided which communicates with the unified TTS interface and transmits requests, in parallel, to each of the remote TTS system and the local TTS system that includes text data for speech generation. In some example, the unified TTS interface prioritizes results from the remote TTS system and uses the results from the local TTS system if the remote TTS system times out, is unstable, or is otherwise not providing acceptable speech generation. Processing requirements are thus reduced while providing a seamless user experience that more quickly returns TTS results that are more accurate than with current solutions.

Furthermore, some conventional solutions provide a negative user experience due to the shifts between the device-based TTS service and a remote-or network-based TTS service. Current solutions typically call the remote-based TTS when a network is working well and available, and call the device-based TTS service when the network is not working well. Because the outputs from the remote-based TTS service and the device-based TTS service can sound completely different, a user will sometimes hear what appears to be two separate voices. This causes a negative end-to-end user experience. Accordingly, various embodiments of the present disclosure provide an improved handoff between device-based TTS services and remote-based TTS services due to shared voice talent data and similar model structures between the device-based TTS services and remote-based TTS services, which substantially removes the differences in prosody, timber, and fidelity between the device-based TTS services and remote-based TTS services.

Aspects of the disclosure describe a remote, remote-based TTS system in contrast to a local, device-based TTS system. In some examples, the terms remote and local are used to differentiate where the two TTS systems perform operations, and this encompasses various configurations. For example, remote means accessible via a network while local means accessible without a network. In other examples, remote means off-device while local means on-device. In still other examples, remote means off-premises while local means on-premises. The terms remote and local may also be differentiated by connection speed. For example, a remote TTS system takes longer to access than a local TTS system.

Aspects of the disclosure are also operable with a first TTS system and a second TTS system, where the second TTS system is more complex and takes longer to process TTS data than the first TTS system. For example, the second TTS system uses machine learning while the first TTS system simply stores cached lookup tables. In another example, the second TTS system is dynamic (e.g., receiving regular or frequent updates) while the first TTS system is static (e.g., irregular or infrequent updates). The first and second TTS systems as described herein may be part of any architecture for converting text data to audio data.

Aspects of the present disclosure are further operable in non-stationary platforms, such as a vehicle, that frequently encounter an unstable network connection or a lack of network connection. The unified TTS interface that communicates with each of the remote system and the local system to reduce processing requirements for the user-facing user applications and reduce the computational resource complexity in order to increase the robustness of the system while maintaining the robustness of the system, as described herein.

FIG. 1 is a block diagram illustrating a system for a hybrid TTS architecture according to an embodiment. The system 100 illustrated in FIG. 1 is provided for illustration only. Other examples of the system 100 can be used without departing from the scope of the present disclosure.

The system 100 includes a user application 110 that is user-facing. The user application 110 receives an input from a user, interacts with a hybrid TTS 120 system, and transmits an output to the user following execution of the hybrid TTS 120 system. For example, the user application 110 receives input from the user in a text format, a gesture format, an audio format, or a combination of text and audio format. In embodiments where the user application 110 receives the input in the audio format, the user application 110 performs speech recognition on the input to convert the input to the text format. The input, now in the text format, is then processed by the hybrid TTS 120 system. In embodiments where the user application 110 receives the input in a text format, additional analysis may not be needed before processing by the hybrid TTS 120 system. In some embodiments, the user application 110 is provided on a computing device, such as the computing apparatus 718 described in greater detail below, that also stores additional hardware and software elements of the system 100. In some embodiments, the user application 110 is provided external to the computing apparatus 718 and data is transmitted from the computing apparatus 718 to user application 110 and from the user application 110 to the computing apparatus 718.

In some embodiments, the user application 110 executes an action in response to the received input. The received input is a command from the user and the action is performed in response to the command. For example, where the system 100 is implemented in an automobile or other vehicle, the received input is an audio command from the user to “turn the volume up.” The user application 110 receives the input to “turn the volume up”, performs initial speech recognition to convert the audio command to text, recognizes the text, and executes the command to “turn the volume up” by increasing the volume output by the stereo of the automobile. In various embodiments, the action is executed before, during, or after the input is transmitted to the hybrid TTS 120 system. For example, the user application 110 executes the action to increase the volume output (a) prior to transmitting the input to “turn the volume up” in text form to the hybrid TTS 120 system, (b) while transmitting the input to “turn the volume up” in text form to the hybrid TTS 120 system, or (c) after transmitting the input to “turn the volume up” in text form to the hybrid TTS 120 system.

The hybrid TTS 120 system is configured to convert the text received from the user application 110 to speech that is then be returned to the user. In the example above, the hybrid TTS 120 system converts the text that responds to the command sent by the user, into speech for consumption by the user. For example, the hybrid TTS 120 system performs a text to speech operation that culminates in the transmission of sound waves, i.e., speech, indicating “the volume has been turned up” in response to the received input. In the example of FIG. 1, the hybrid TTS 120 system includes a unified TTS interface 121, a cache 123, a policy controller 125, a device TTS 127, and a device model manager 129. The hybrid TTS 120 system communicates with a remote TTS 130 that is physically located external to the components that execute the unified TTS interface 121, cache 123, policy controller 125, device TTS 127, and device model manager 129.

The device TTS 127 is a TTS program executed locally on an electronic device, in some examples. For example, in embodiments where the system 100 is implemented in an automobile, the device TTS 127 is a TTS program stored and executed in a memory of the automobile. The device TTS 127 receives text input, processes the input from text to speech, and returns a speech output to be transmitted to the user in the form of sound waves.

The remote TTS 130 is a TTS program executed remotely from the device, such as in the cloud, in some examples. For example, the remote TTS 130 is a TTS program that receives text input, processes the input from text to speech, and returns a speech output to be transmitted to the user in the form of sound waves, but the TTS program is stored and executed remotely rather than locally on the electronic device. In some examples, the remote TTS 130 provides higher quality text to speech processing to return more accurate results than the device TTS 127, but typically requires a network connection to be accessed. In contrast, the device TTS 127 typically does not require a network connection to be accessed and is therefore generally faster and more readily available than the remote TTS 130.

The unified TTS interface 121 is a unified, hybrid TTS API, software development kit (SDK), or other routines in the hybrid TTS 120 system. The unified TTS interface 121 operates to hide the details and differences involved with communicating with the device TTS 127 and the remote TTS 130. The unified TTS interface 121 receives the text from the user application 110. In some embodiments, the received text refers to the action that has been or will be executed. In the example above, the received text is “the volume has been turned up.” In other embodiments, the received text is the input from the user in text form, and the hybrid TTS 120 system performs a lookup or other conversion to identify a response to the input from the user. For example, the received text is “turn up the volume” as input by the user. In these embodiments, the unified TTS interface 121 converts the received input to a response to be output based on the executed action, such as “the volume has been turned up”.

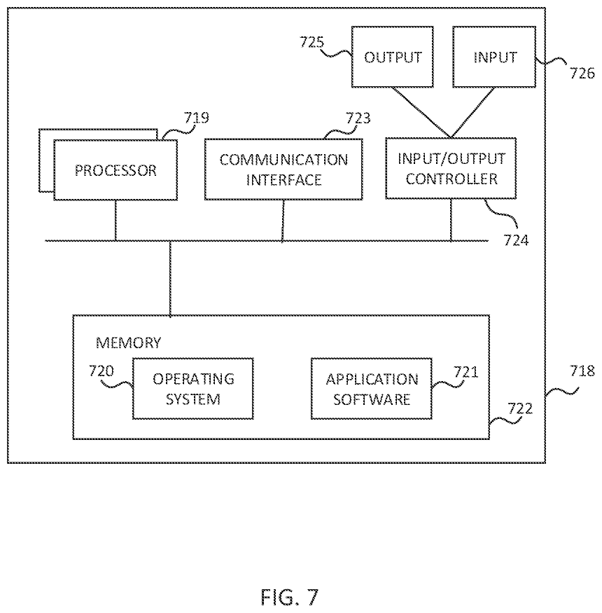

The cache 123 stores a mapping between text and corresponding sound waves. For example, the cache 123 stores one or more of words, phrases, and sentences that are output to a user as sound waves in response to the received text input. The example cache 123 is a software component, such as a database stored remotely, for example in the cloud, or a hardware component, such as a database stored in the memory 722 and further described in the description of FIG. 7. The cache 123 is configured to store inputs and corresponding outputs for various mappings, based on recency or frequency. The input corresponds to textual data received by the unified TTS interface 121 and the corresponding outputs correspond to speech data that provides a response to the textual data. For example, an input that includes textual data of “Hi car, please open the sunroof” has corresponding outputs of speech data of “The sunroof is now open” and/or “The sunroof cannot be opened”. As another example, an input that includes textual data of “Hi car, play some music please” has corresponding outputs of speech data of “playing music for you now” and/or “music is unavailable right now”.

In some embodiments, the cache 123 stores one or more markers in received textual data, which corresponds to speech data. The marker can be any marking, such as a mapping, a key, an index, and so forth, to identify particular textual data and its corresponding speech data. The one or more markers can be embedded in the input text and then associated, or appended, to each audio file containing the corresponding speech data. As described in greater detail below, the policy controller 125 utilizes the one or more markers to combine particular sentences when selecting received speech data from one or more of the device TTS 127 and the remote TTS 130.

In some embodiments, the cache 123 stores the most recent input and corresponding output. In some embodiments, the cache 123 stores a particular quantity of recent inputs and corresponding outputs, such as the three most recent inputs and corresponding outputs, five most recent inputs and corresponding outputs, or any other suitable number of recent inputs and corresponding outputs. In some embodiments, the cache 123 stores recent inputs and corresponding outputs for a particular amount of time. For example, the cache 123 stores inputs and corresponding outputs from the previous minute, the previous five minutes, the previous hour, and so forth. Once the unified TTS interface 121 receives an input from the user application 110, the unified TTS interface 121 searches the cache 123 to identify whether the received input is stored in the cache 123. In instances where the received input is stored in the cache 123, the corresponding output is returned, e.g., output to the user, directly and quickly by bypassing the remote TTS 130 and the device TTS 127 because the text to speech function executed by the remote TTS 130 and the device TTS 127 has already been performed recently. Returning the corresponding output directly and quickly provides a mechanism to reduce latency of the system 100 and to enhance the seamless user experience provided by the present disclosure. In instances where the received input is not stored in the cache 123, the received input progresses to the policy controller 125.

The policy controller 125 controls how the device TTS 127 and remote TTS 130 are utilized within the system 100. In some embodiments, the policy controller 125 operates based on preset rules and/or customized rules or policies that are input by a user. For example, the policy controller 125 operates based on selection policies including one or more of cognition-driven policies, performance-driven policies, and quality-driven policies. One or more of the policies are set by a user, by default in the system 100 (e.g., by a system administrator or manufacturer or provider of the TTS systems), by other users (e.g., crowd-sourced), and the like. Example cognition-driven policies include forcing the system 100 to utilize the device TTS 127 over the remote TTS 130, forcing the system 100 to utilize a percentage of the remote TTS 130, and so forth. Example performance-driven policies include using whichever of the device TTS 127 and the remote TTS 130 that will provide faster results, whichever of the device TTS 127 and the remote TTS 130 that will provide more accurate results, and so forth. This may be based on historical performance data. Example quality-driven policies include forcing the system 100 to utilize the remote TTS 130 over the device TTS 127 (assuming the remote TTS 130 provides higher-quality output), utilizing the device TTS 127 only in response to the remote TTS 130 timing out, and so forth.

In some embodiments, the selection policies vary between users and the system 100 enable different users to set different rules or policies. For example, where the system 100 is implemented in an automobile, the automobile is shared between different users, such as members of a household. In this example, one member of the household prefers one set of rules, such as performance-driven, while another member of the household prefers another set of rules, such as quality-driven. The preferences of each user of the system 100 is saved and stored, for example in the memory 722, and selected prior to each use of the system 100. In some embodiments, the selection policies change or update during use of the system 100. For example, the user updates the selection policies used by the system or selects to revert back to the preset rules.

The policy controller 125 calls the device TTS 127 and the remote TTS 130 according to the selection policies described herein. In other words, the policy controller 125 sends textual data to one or both of the device TTS 128 and the remote TTS 130 according to the selection policies. In some embodiments, the policy controller 125 calls only the device TTS 127. For example, the system 100 will call only the device TTS 127, and not call the remote TTS 130, based on a selection policy forcing the system 100 to utilize the device TTS 127, or based on the remote TTS 130 being unavailable due to a poor or unavailable network connection. In some embodiments, the policy controller 125 calls only the remote TTS 130. For example, the system 100 calls only the remote TTS 130, and does not call the device TTS 127, based on a selection policy forcing the system 100 to utilize the remote TTS 130. In some embodiments, the policy controller 125 calls both the device TTS 127 and the remote TTS 130. In embodiments where both the device TTS 127 and the remote TTS 130, the policy controller 125 selects returned results from the device TTS 127 and the remote TTS 130 or combines some aspects of the output from the device TTS 127 and the remote TTS 130 based on the selection policies.

In some embodiments where speech data is returned from both the device TTS 127 and the remote TTS 130, the policy controller 125 selects speech data from one of the device TTS 127 and the remote TTS 130 and discards the speech data from the non-selected TTS. In other words, the speech data received from the device TTS 127 is selected and the speech data received from the remote TTS 130 is discarded or the speech data received from the remote TTS 130 is selected and the speech data received from the device TTS 127 is discarded. In some embodiments, the selection of speech data received from the device TTS 127 and the remote TTS 130 can be performed based on the selection policy described herein. For example, where a quality-driven selection policy is implemented, the policy controller 125 selects the speech data identified as having the higher quality. Quality can be identified based on an analysis comparing the speech data received from the device TTS 127 and the remote TTS 130 or based on a default quality assumption. For example, a default quality assumption assumes that the quality of speech data received from the remote TTS 130 exceeds the quality of speech data received from the device TTS 127. In another example, where a cognition-driven selection policy is implemented and the policy controller 125 utilizes a certain percentage of speech data received from each of the device TTS 127 and the remote TTS 130, the policy controller 125 selects the received speech data in accordance with maintaining the specified percentages.

As described herein, in some embodiments the non-selected speech data is discarded. In other words, the non-selected speech data is not stored in the cache 123 or other memory. Only the selected speech data is stored in the cache 123 as described in various embodiments herein.

In some embodiments, the policy controller 125 receives the speech data generated from one or both of the device TTS 127 and the remote TTS 130. Upon receipt of the speech data, the policy controller 125 sends the speech data to the user application 110, which in turn sends the speech data to an output component 140 to output the speech data.

The device model manager 129 provides updating and downloading of the system 100. The updating and downloading of the system 100 is performed automatically by the device model manager 129 in some examples. In other words, the device model manager 129 operates to update the system 100 and download new versions of the system 100 without any additional action needed by the user. The device model manager 129 reviews a model hosting server at regular intervals, such as daily, weekly, etc. If the device model manager 129 finds there is a new version of the system 100, the device model manager 129 will begin a download and upgrade according to user settings, such as notifying the user prior to upgrading or directly upgrading. As such, the device model manager 129 enables users to avoid handle downloading, storage, and upgrading in the system by updating and downloading automatically. For example, the device model manager 129 performs the downloading, storage, and upgrading with configuration codes, such as where to put the system 100, where the model hosting server is located, and how the system 100 will be upgraded.

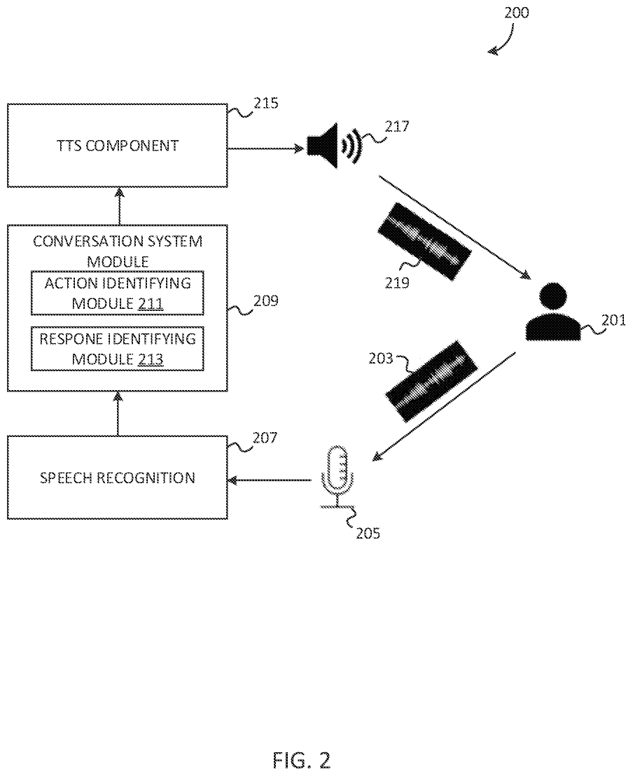

FIG. 2 is a block diagram illustrating a system for a hybrid TTS system according to an embodiment. The system 200 illustrated in FIG. 2 is provided for illustration only. Other examples of the system 200 can be used without departing from the scope of the present disclosure.

The system 200 includes an input detection device 205, a speech recognition module 207, a conversation system module 209, a TTS component 215, and an output device 217. The input detection device 205 receives an input 203 from a user 201. In some embodiments, the input detection device 205 is a device that receives an audio input 203, such as a microphone. In some embodiments, the input detection device 205 is a device that receives a text input 203, such as a keyboard, a touch display, a touchpad, and so forth. In some embodiments, the input detection device 205 is a device with integrated audio and text input receptors, such as a display that receives a text input with an integrated microphone. For example, in embodiments where the system 200 is implemented in an automobile, the input detection device 205 is implemented in a user interface, displayed inside the automobile, configured to receive a text input 203, that further includes a microphone configured to receive an audio input 203 and integrated into the user interface or provided externally to but communicatively coupled to the user interface.

In other examples, the input detection device 205 is a gesture-recognition device (e.g., camera plus recognition engine) that detects gestures made by the user and converts those to actions.

The speech recognition module 207 recognizes and identifies speech in the input received by the input detection device 205. The speech recognition module 207 interprets the sound waves received by the input detection device 205, recognizes the patterns in the sound waves, and converts the patterns into the beginning of the conversation. For example, the speech recognition module 207 recognizes and identifies the speech in the input received by the input detection device 205 to be a command such as “Hi car, play some music please.” The identified speech is output to the conversation system module 209.

The conversation system module 209 receives the identified speech from the speech recognition module 207, identifies an action associated with the identified speech, and identifies a response to the identified speech. For example, an action identifying module 211 of the conversation system module 209 identifies the action for the identified speech and a response identifying module 213 of the conversation system module 209 identifies the response to the identified speech. For example, where the identified speech is “Hi car, play some music please”, the identified action is playing music and the identified response is “playing music for you now”. In some embodiments, the response identifying module 213 identifies the response based at least in part on the results of the action identifying module 211. For example, the response identifying module 213 determines that the identified action is possible before identifying a confirmation response. Where the conversation system module 209 identifies the action as playing music, but music is unavailable to be played, the response identifying module 213 does not identify “playing music for you now” as the response but identifies a response indicating that the music is unavailable, such as “music is unavailable right now”. In another example, the action identifying module 211 requires additional information to execute the action and, based on this, the response identifying module 213 identifies a response that requests additional information such as “please select a song”, “please select an artist”, “please select a genre”, and so forth.

The TTS component 215 converts the identified response from the response identifying module 213 to an output that is returned to the user 201 using an output device. In the example above where the response identifying module 213 identifies the response as “playing music for you”, the TTS component 215 converts “playing music for you” to the proper format, e.g., visual text or sound waves, based on the format of the output device 217. In embodiments where the output device 217 is a stereo, a speaker, or any other device that outputs sound waves, the TTS component 215 converts “playing music for you” into corresponding sound waves to be output to the user 201. In embodiments where the output device 217 is a display, a user interface, or any other device that visually displays an output, the TTS component 215 converts “playing music for you” into a text format that is output for the user 201 to read. In some embodiments, the output device 217 is a device with integrated outputs for both audio and text, such as a display that displays a text output with an integrated speaker. For example, in embodiments where the system 200 is implemented in an automobile, the output device 217 is implemented in a user interface displayed inside the automobile, configured to display a text output 219, that further includes a speaker configured to output an audio output 219 that is integrated into the user interface or provided externally to, but communicatively coupled to, the user interface.

In some embodiments, the TTS component 215 includes both the device TTS 127 and the remote TTS 130 illustrated in FIG. 1. Particularly in embodiments where the system 200 is implemented in an automobile, the TTS component 215 provides several advantages by including both the device TTS 127 and the remote TTS 130. The device TTS 127 and the remote TTS 130 include the same voice talent data and a similar model structure, which enables the prosody, timber, and fidelity to be similar, if not substantially identical, between output from the device TTS 127 and the remote TTS 130. In other words, the voice used to output speech data generated from both the device TTS 127 and the remote TTS 130 sounds, to a user, identical or nearly identical, which contributes to a seamless user experience. The seamless user experience improves upon current solutions which are unable to seamlessly switch between voice talent provided in local TTS services and remote TTS services, particularly in instances where speech data from local TTS services and remote TTS services are combined into comprehensive speech data. In contrast, the present application provides a seamless user experience where a user may not be able to distinguish between speech data generated by the device TTS 127 and the remote TTS 130. Furthermore, as described above, conventional solutions that attempt to utilize both a local TTS service and a remote TTS service call the remote TTS when a network is working well and available and call the local TTS service when the network is not working well, which causes a negative end-to-end user experience due to the difference in the generated speech data.

Although described herein as various components, some components can be combined, added, or omitted without departing from the scope of the present disclosure. For example, the input detection device 205 and the output device 217 are integrated into a single device, such as a user interface, that is configured to perform both the input and output functions of the system 200. TTS component 215 includes one or both of the device TTS 127 and the remote TTS 130 illustrated in FIG. 1. Accordingly, the TTS component 215 provides an improved handoff between device TTS 127 and the remote TTS 130 due to shared voice talent data and similar model structures between the device TTS 127 and the remote TTS 130, which substantially removes the differences in prosody, timber, and fidelity between the device TTS 127 and the remote TTS 130.

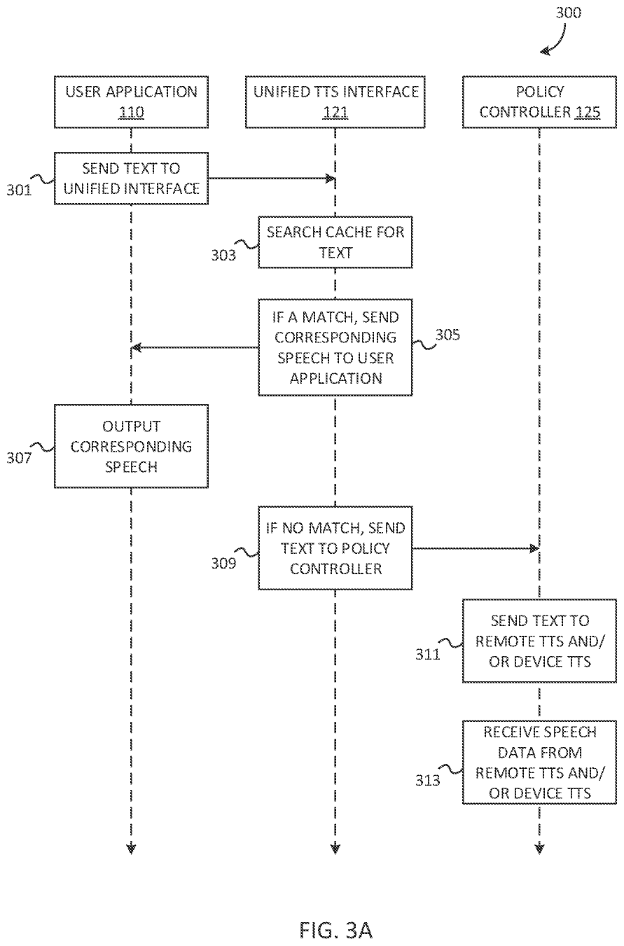

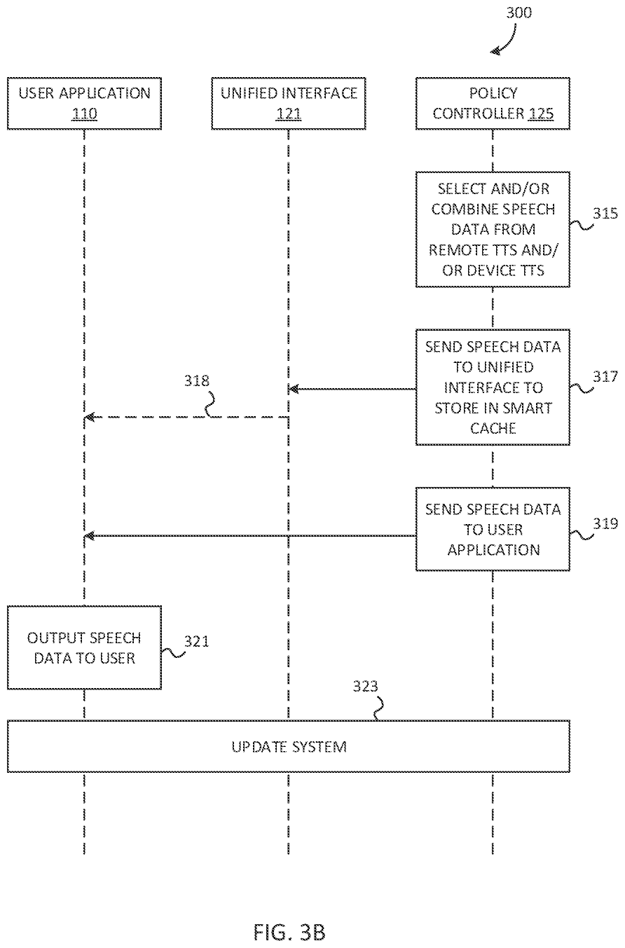

FIGS. 3A and 3B are sequence diagrams illustrating a computerized method for a hybrid TTS system according to an embodiment. The method 300 illustrated in FIGS. 3A and 3B is for illustration only. FIG. 3B extends FIG. 3A and is a continuation of the method 300 which begins in FIG. 3A. Other examples of the method 300 can be used without departing from the scope of the present disclosure. The method 300 can be implemented by one or more components of the system 100 illustrated in FIG. 1, such as the components of the computing apparatus 718 described in greater detail below in the description of FIG. 7. For example, FIGS. 3A and 3B illustrate the method 300 as performed by the user application 110, the unified TTS interface 121, and the policy controller 125 of the system 100, but various embodiments are contemplated.

The method 300 begins by the user application 110 sending an input to the unified TTS interface 121 at operation 301. The input includes textual data. For example, the textual data is the response identified by the response identifying module 213 of the conversation system module 209. The textual data includes words, phrases, sentences, and the like. The textual data is organized into textual versions of responses to commands, the commands including “Hi car, play some music please” or “Hi car, will you please play some music?” as examples input by the user. In these embodiments, the textual data includes either an affirmative response, such as “playing music now” if the command or question is accomplished, or a negative response, such as “music is unavailable” if the command or question is not able to be answered in the affirmative.

In operation 303, the unified TTS interface 121 searches the cache for the textual data received from the user application 110 to identify whether the received textual data is stored in the cache 123. In some embodiments, the unified TTS interface 121 searches for a particular keyword from the textual data in the cache 123. For example, where the textual data recites “playing music now”, the unified TTS interface 121 searches for the keyword “music” in the cache 123. If the keyword “music” matches an entry stored in the cache 123, the unified TTS interface 121 performs additional analysis to confirm the entire textual data matches the entry stored in the cache 123. For example, an entry of “music is unavailable” stored in the cache 123 returns a result based on the keyword “music”, but the entire textual data of “playing music now” does not match an entirety of the entry stored in the cache 123. Therefore, an entry of “music is unavailable” stored in the cache 123 does not match the textual data “playing music now”. If the unified TTS interface 121 confirms a match between the textual data and an entry stored in the cache 123, the method 300 progresses to operation 305. If the unified TTS interface 121 is unable to confirm a match between the textual data and an entry stored in the cache 123, the method 300 progresses to operation 309.

In operation 305, the unified TTS interface 121 confirms a match between the textual data and an entry stored in the cache 123 and sends speech data corresponding to the entry stored in the cache 123 to the user application 110 for output. In other words, the speech data is transmitted directly to the user application 110 and both the device TTS 127 and the remote TTS 130 are bypassed. In some embodiments, the speech data includes instructions for sound waves that correspond to the text of the entry stored in the cache 123. For example, where the textual data is “playing music now” and a matching entry of “playing music now” is stored in the cache 123, the speech data transmitted to the user application 110 is sound waves corresponding to the text of “playing music now”. In operation 307, in response to receiving the speech data, the user application 110 outputs the sound waves corresponding to the textual data, for example using the output device 217. In other embodiments, the speech data sent by the unified TTS interface 121 in operation 305 is a text output of the entry stored in the cache 123, and the user application 110 outputs, via the output device 217, the text output in operation 307. In operation 309, based on the unified TTS interface 121 not confirming a match between the textual data and an entry stored in the cache 123, the unified TTS interface 121 sends the textual data to the policy controller 125.

In operation 311, the policy controller 125 sends the textual data to at least one of the device TTS 127 or the remote TTS 130. In other words, the policy controller 125 sends the textual data to only the device TTS 127, only the remote TTS 130, or both the device TTS 127 and the remote TTS 130. In some embodiments, the policy controller 125 determines whether to send the textual data to one or both of the device TTS 127 or the remote TTS 130 based on a policy such as a transmission policy. In some examples, the transmission policy is based at least in part on a selection policy, which is used to determine whether speech data from the device TTS 127 or the remote TTS 130, or a combination of both, is selected to be used for an output by the user application 110. The selection policy is described in greater detail below. If the selection policy indicates that only speech data from the device TTS 127 is to be selected, the transmission policy indicates that the textual data should only be sent to the device TTS 127. Likewise, if the selection policy indicates that only speech data from the remote TTS 130 is to be selected, the transmission policy indicates that the textual data should only be sent to the remote TTS 130. If the selection policy indicates that speech data from either or both of the device TTS 127 and the remote TTS 130 may be used, the transmission policy indicates that the textual data is to be sent to both the device TTS 127 and the remote TTS 130 in parallel for analysis. Based on receiving the textual data, the TTS systems perform text to speech analysis of the textual data and generate speech data corresponding to the textual data.

In an embodiment, the policy controller 125 sends the textual data to both the device TTS 127 and to the remote TTS 130. In other words, the policy controller 125 sends the textual data to the device TTS 127 for analysis and sends the textual data to the remote TTS 130, via a network connection, for analysis. In this embodiment, each of the device TTS 127 and the remote TTS 130 receive the textual data from the policy controller 125 and perform text to speech analysis of the textual data to generate corresponding speech data. For example, each of the device TTS 127 and the remote TTS 130 generate sound wave data, or instructions for outputting sound wave data, that correspond to the received textual data. The device TTS 127 and the remote TTS 130 generate the sound waves data independently. For example, program code for the operation of the device TTS 127 to generate sound waves corresponding to the textual data is executed independently of the program code for the operation of the remote TTS 130. In other words, both the device TTS 127 and the remote TTS 130 function independently to generate sound waves corresponding to the textual data. In the example above, where the textual data is for the text “playing music now”, both the device TTS 127 and the remote TTS 130 generate sound waves corresponding to the phrase “playing music now”. Following the generation of the speech data, e.g., the sound waves corresponding to the textual data, the device TTS 127 and the remote TTS 130 each transmit the speech data to the policy controller 125.

In operation 313, the policy controller 125 receives the speech data from the TTS systems, e.g., the device TTS 127 and the remote TTS 130. In embodiments where the textual data was sent to only one TTS system, such as only to the device TTS 127 or only to the remote TTS 130, the policy controller 125 receives the speech data only from the TTS system to which the textual data was sent. In embodiments where the textual data was sent to both the device TTS 127 and the remote TTS 130, the policy controller 125 anticipates reception of corresponding speech data from both the device TTS 127 and the remote TTS 130. However, embodiments of the present disclosure recognize and take into account that speech data may not always be received from each of the device TTS 127 and the remote TTS 130 when it is anticipated. For example, although the policy controller 125 anticipates receipt of speech data from the remote TTS 130, a dropped network connection causes receipt of the speech data to not be received or causes the transmission of the speech data to be delayed or otherwise take longer than anticipated.

In operation 315, the policy controller 125 selects, based on the selection policy, the speech data generated from at least one of the device TTS 127 or the remote TTS 130. In other words, the policy controller 125 selects speech data from only the device TTS 127, only the remote TTS 130, or both the device TTS 127 and remote TTS 130. As described herein, the policy controller 125 selects the speech data based on the selection policy. The selection policy includes, for example, one or more of: one or more cognition-driven policies, one or more performance-driven policies, and one or more quality-driven policies. Cognition-driven policies include, for example, forcing the system 100 to utilize the device TTS 127 over the remote TTS 130, forcing the system 100 not to utilize the remote TTS 130, forcing the system 100 to utilize a percentage of the remote TTS 130, and so forth. Performance-driven policies include, for example, using whichever of the device TTS 127 and the remote TTS 130 that provide faster results, whichever of the device TTS 127 and the remote TTS 130 that provide more accurate results, and so forth. Quality-driven policies include, for example, forcing the system 100 to utilize the remote TTS 130 over the device TTS 127, forcing the system 100 not to utilize the device TTS 127, utilizing the device TTS 127 in response to the remote TTS 130 timing out, and so forth.

In various examples, the policy controller 125 selects the speech data from one of the device TTS 127 and/or the remote TTS 130 based on either a reactive selection policy or a proactive selection policy. For example, in response to the network connection timing out and the remote TTS 130 therefore being unavailable, the policy controller 125 reactively selects the speech data from the device TTS 127. In this example, the policy controller 125 has reactively selected the device TTS 127 as the engine to provide TTS. As another example, if the policy controller 125 knows that one or more computing resources (e.g., bandwidth, processing load, memory, etc.) of the device that includes the device TTS 127 are above a threshold value or otherwise full or at capacity, the policy controller 125 proactively decides to select the speech data from the remote TTS 130. In such an example, the device TTS 127 may stop processing the text data to preserve the remaining computing resources, once the policy controller 125 becomes aware of the computing resource levels of the device TTS 127 (e.g., the policy controller 125 may send a signal to the device TTS 127 to stop processing the text data).

The transmission policy is based at least in part on the selection policy and can also be implemented reactively or proactively. For example, the policy controller 125 takes into account the computing and processing status (e.g., load or level) of the device TTS 127 and/or the device that includes the device TTS 127, such as the latency, bandwidth, and processing load, and proactively decides to send the textual data to the device TTS 127 or remote TTS 130 or both. As an example, if the processing load of the device that includes the device TTS 127 is above a threshold value, the policy controller 125 sends the textual data only to the remote TTS 130 (e.g., to preserve the remaining computing resources available on the device including the device TTS 127). In this example, the policy controller 125 has proactively selected the remote TTS 130 as the engine to provide TTS.

In another example, in embodiments where the selection policy is a cognition-driven policy forcing the system 100 to utilize the device TTS 127 only, the transmission policy drives the policy controller 125 to transmit the textual data to the device TTS 127 only because speech data from the remote TTS 130 will not be used due to this particular selection policy. In yet another example, in embodiments where the selection policy is a quality-driven policy forcing the system 100 to utilize the remote TTS 130 only, the transmission policy drives the policy controller 125 to transmit the textual data to the remote TTS 130 only because speech data from the device TTS 127 will not be used due to this particular selection policy. In yet another example, in embodiments where the selection policy specifies a preference of one TTS system over the other or specifies a percentage of times a particular TTS system is utilized, the transmission policy drives the policy controller 125 to transmit the textual data to both the device TTS 127 and the remote TTS 130.

In some embodiments, selecting the speech data from the device TTS 127 and the remote TTS 130 includes combining some of the speech data from the device TTS 127 and some of the speech data from the remote TTS 130. For example, a performance-driven policy drives the system 100 to provide the fastest speech data results possible. While the policy controller 125 is in the process of receiving the speech data corresponding to “music playing now” from the remote TTS 130, the network connection is dropped and only a portion of the speech data is received, such as “music playing”. Under the performance-driven policy, the policy controller 125 is able to utilize “music playing” received from the remote TTS 130 and supplement the rest of the phrase, such as “now” using the speech data received from the device TTS 127. Thus, the combination of “music playing” received from the remote TTS 130 and “now” received from the device TTS 127 provides the comprehensive combined speech data of “music playing now” and is consistent with the performance-driven policy. As such, the policy controller 125 combines selected speech data into comprehensive speech data that includes at least a portion of the speech data generated from the remote TTS 130 and at least a portion of the speech data generated from the device TTS 127.

In some embodiments, the selection and combination of speech data generated from the device TTS 127 and the remote TTS 130 is performed at a per-sentence level. For example, the textual data can include multiple sentences, such as “Music playing now. Please select an artist.” The policy controller 125 can select speech data received from one TTS system, such as the remote TTS 130, for “Music playing now.” and speech data received from the other TTS system, such as the device TTS 127, for “Please select an artist”. The policy controller combines “Music playing now” received from the remote TTS 130 and “Please select an artist” received from the device TTS 127 to produce the full speech data of “Music playing now. Please select an artist.” The combination of different sentences can be implemented, for example, where “Music playing now” is received from the remote TTS 130, but the network between the policy controller 125 and the remote TTS 130 is disconnected prior to receiving the speech data corresponding to “Please select an artist” is received by the policy controller 125 from the remote TTS 130. In some embodiments, the policy controller 125 combines sentences based on the one or more markers stored in the cache 123 and described in greater detail above. For example, the policy controller 125 identifies a first marker embedded in the textual data received for “Music playing now” and a second marker embedded in the textual data received for “Please select an artist”. The policy controller 125 identifies corresponding markers embedded in the received speech data to associate speech data with the appropriate textual data to combine the correct sentences in the correct order.

In other embodiments, instead of combining speech data received from the remote TTS 130 and the device TTS 127, the policy controller 125 outputs an error message. For example, the output 140 is an error message informing the user of the status of the network disconnection. An example error message can be speech data indicating “Network disconnected, please try again.” In some embodiments, the error message is stored in the cache 123 and for retrieval by the policy controller 125. In some embodiments, the error message is further pinned in the cache 123 to prevent deletion from the cache 123.

In some embodiments, the policy controller 125 utilizes entire speech data received from either the device TTS 127 or the remote TTS 130. For example, where the textual data describes “music playing now” as described in the example above, if the received speech data from one TTS system is incomplete, e.g., the speech data received from the remote TTS 130 includes only “music playing”, the policy controller 125 selects only the received speech data from the device TTS 127 that is identified to be complete. The incomplete speech data received from the remote TTS 130 that includes only “music playing” is then discarded.

In operation 317, the policy controller 125 sends the speech data to the unified TTS interface 121 to be stored in the cache 123. As described herein, the cache 123 stores recent inputs and corresponding outputs. For example, the cache 123 stores a particular quantity of recent inputs and corresponding outputs or stores recent inputs and corresponding outputs for a particular period of time. In embodiments where the cache 123 stores a particular quantity of recent inputs and corresponding outputs, the speech data is stored in the cache 123 as the most recent input and corresponding output. In embodiments where the cache 123 stores recent inputs and corresponding outputs for a particular period of time, the speech data is stored in the cache 123 for the particular period of time.

In operation 319, the policy controller 125 sends the speech data to the user application 110. In operation 321, the user application 110 controls output of the speech data to a user. For example, as described in FIG. 2, the output device 217 outputs the speech data as the output 219 to the user 201. Optionally, the unified TTS interface 121 sends the speech data to the user application 110 in operation 318, rather than the policy controller 125 sending the speech data to the user application 110.

In operation 323, the system 100 is updated. For example, as described above, the device model manager 129 updates and downloads the system 100. In some embodiments, the device model manager 129 automatically updates the system 100 without additional action needed by the user.

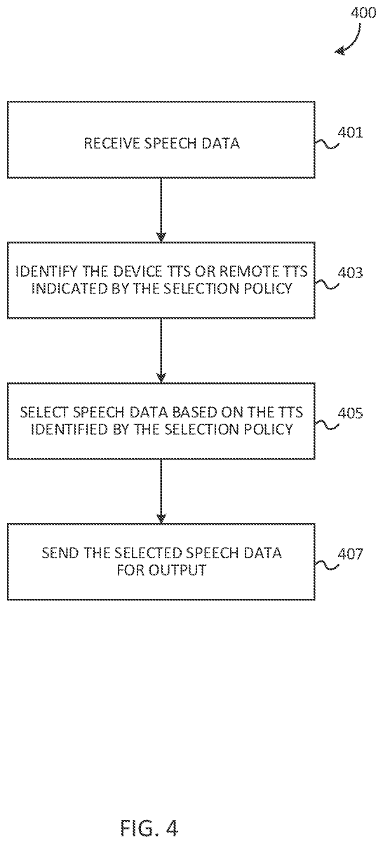

FIG. 4 is a flowchart illustrating a computerized method for selecting speech data from one or more of a remote TTS or a local TTS according to an embodiment. The method 400 illustrated in FIG. 4 is for illustration only. Other examples of the method 400 can be used without departing from the scope of the present disclosure. The method 400 can be implemented by one or more components of the system 100 illustrated in FIG. 1, such as the components of the computing apparatus 718 described in greater detail below in the description of FIG. 7.

The method 400 begins with the unified TTS interface 121 receiving speech data at operation 401. More particularly, the policy controller 125 receives speech data from a TTS service or device corresponding to textual data previously received by the policy controller 125 from the unified TTS interface 121 and transmitted, by the policy controller 125, to the device TTS 127 and the remote TTS 130. In some embodiments, the speech data is received in the form of the sound waves that correspond to the textual data received from the unified TTS interface 121.

In operation 403, the policy controller 125 identifies the TTS service indicated by a selection policy. As described herein, the selection policy indicates whether speech data received from the device TTS 127, the remote TTS 130, or both the device TTS 127 and the remote TTS 130 is selected for output by the policy controller 125. The selection policy includes one or more of cognition-driven policies, performance-driven policies, and quality-driven policies. Cognition-driven policies include forcing the system 100 to utilize the device TTS 127 over the remote TTS 130, forcing the system 100 not to utilize the remote TTS 130, forcing the system 100 to utilize a percentage of the remote TTS 130, and so forth. Performance-driven policies include using whichever of the device TTS 127 and the remote TTS 130 that will provide faster results, whichever of the device TTS 127 and the remote TTS 130 that will provide more accurate results, and so forth. Quality-driven policies include forcing the system 100 to utilize the remote TTS 130 over the device TTS 127, forcing the system 100 not to utilize the device TTS 127, utilizing the device TTS 127 in response to the remote TTS 130 timing out, and so forth. In some embodiments, the selection policy is preset, and includes preset rules and policies used to select the speech data. For example, preset selection policies are referred to as default selection policies, preloaded selection policies, and so forth. In some embodiments, the preset selection policies are changed, updated, or overwritten by selection policies that are customized by a user of the system 100. In some embodiments, the selection policy is initially not set or selected and a selection policy is first selected, or set, by a user prior to execution of the system 100.

In some embodiments, the data from the selection policy is implemented in a neural network or machine learning (ML) feedback loop, which functions to automatically improve and upgrade the selection of a TTS service based on the selection policy. For example, the selection policy includes a performance-driven policy. Each time textual data is sent to the device TTS 127 and the remote TTS 130 and speech data is returned from the device TTS 127 and the remote TTS 130 based on the textual data, the neural network uses the received data to update the performance-driven policy. By updating the performance-driven policy, the policy controller 125 is able to make a more efficient selection of generated speech data from either the device TTS 127 or the remote TTS 130 in the future.

In operation 405, the policy controller 125 selects the speech data from the device TTS 127, the remote TTS 130, or both the device TTS 127 and the remote TTS 130 based on the identification in operation 403. For example, in embodiments where the selection policy is a performance-driven policy that utilizes speech data generated from the device TTS 127 or the remote TTS 130 that provides faster results, the policy controller 125 selects the first generated speech data that is received. As another example, where the selection policy is a quality-driven policy that utilizes speech data from the remote TTS 130 over the device TTS 127, the policy controller 125 selects the speech data generated by the remote TTS 130 if the speech data is available and may only utilize the speech data generated by the device TTS 127 if speech data generated by the remote TTS 130 is unavailable.

In operation 407, the policy controller 125 sends, or transmits, the selected speech data for output. For example, the policy controller 125 sends the selected speech data, selected based on the selection policy, to the user application 110 for outputting to the user. The user application 110 controls an output device, such as the output device 217, to transmit the speech data to a user 201 as an output 219.

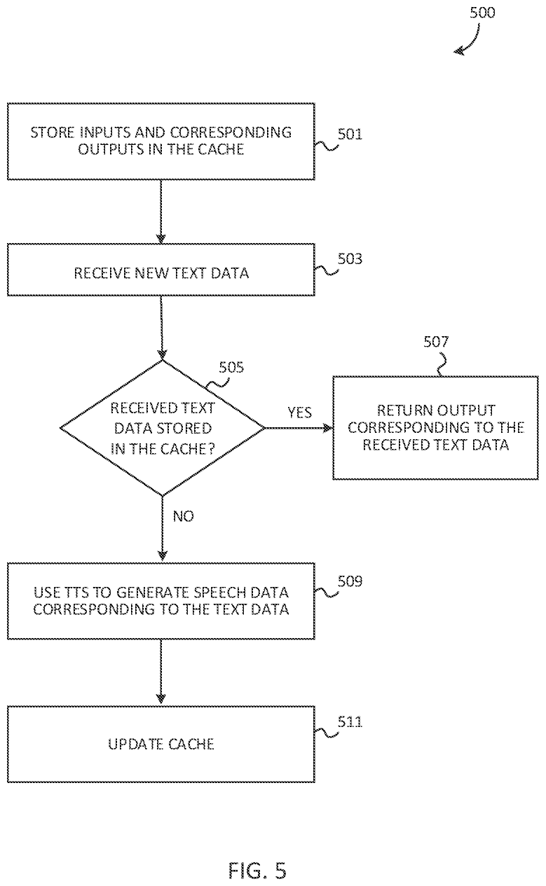

FIG. 5 is a flowchart illustrating a computerized method for operating a cache according to an embodiment. The method 500 illustrated in FIG. 5 is for illustration only. Other examples of the method 500 can be used without departing from the scope of the present disclosure. The method 500 can be implemented by one or more components of the system 100 illustrated in FIG. 1, such as the components of the computing apparatus 718 described in greater detail below in the description of FIG. 7.

The method 500 begins by storing inputs and corresponding outputs in the cache 123 in operation 501. For example, in operation 407 of the method 400, the policy controller 125 sends the selected speech data to the cache 123 to be stored in addition to sending the selected speech data for output. In some examples, the cache 123 is either a software component, such as a database stored remotely, for example in the cloud, or a hardware component, such as a database stored in the memory 722 and further described in the description of FIG. 7, that stores recent inputs and corresponding outputs utilized by the system 100. The cache 123 stores inputs and corresponding outputs for a particular period of time, stores a particular quantity of recent inputs and corresponding outputs, stores a range of quantities of recent inputs and corresponding outputs, or a combination of these. In these embodiments, the contents of the cache 123 are regularly updated to store recent inputs and corresponding outputs.

In some embodiments, the cache 123 stores frequently inputs and corresponding outputs that are frequently received and output, respectively. These inputs and corresponding outputs are preset, or pinned, to the cache 123 and are not regularly and automatically updated or removed, in some examples. In these embodiments, updates to the inputs and corresponding outputs are manually performed, such as by the user, and are stored until they are manually removed.

In operation 503, the unified TTS interface 121 receives new textual data. In operation 505, the unified TTS interface 121 determines whether the received textual data is stored as an input in the cache 123. In order to determine whether the received textual data is stored as an input in the cache 123, the unified TTS interface 121 begins by searching the cache 123 for a keyword included in the received input. For example, where the textual data recites “playing music now”, the unified TTS interface 121 searches for the keyword “music” in the cache 123. If the keyword “music” matches an entry stored in the cache 123, the unified TTS interface 121 performs additional analysis to confirm the entire textual data matches the entry stored in the cache 123. For example, an entry of “music is unavailable” stored in the cache 123 would return a result based on the keyword “music”, but the entire textual data of “playing music now” does not match an entirety of the entry stored in the cache 123. Therefore, an entry of “music is unavailable” stored in the cache 123 does not match the textual data “playing music now”. In contrast, an entry of “playing music now” stored in the cache 123 does match the entire textual data and a match of the textual data to the entry in stored in the cache 123 is confirmed. If the received textual data is determined to be stored in the cache 123, the method 500 proceeds to operation 507. If the received textual data is determined not to be stored in the cache 123, or if the received textual data cannot be confirmed to be stored in the cache 123, the method 500 proceeds to operation 509.

In operation 507, the system 100 returns the output stored in the cache 123 that corresponds to the received textual data input. The returned output is speech data that corresponds to the textual data input. The unified TTS interface 121 then outputs the corresponding output to a user. For example, as illustrated in FIG. 2, the user application 110 controls the output device 217 to transmit the output 219 to the user 201. By storing speech data previously generated by the device TTS 127 and/or remote TTS 130 for rapid output by the system 100, various embodiments of the present disclosure enable a rapid, efficient return of an output that corresponds to a received input by utilizing speech data previously generated by the device TTS 127 and/or remote TTS 130, providing quick, accurate, efficient results while reducing redundancy in previously executed operations.

In operation 509, based on the received textual data not being stored in the cache 123, the policy controller 125 utilizes the TTS systems to generate speech data corresponding to the textual data. For example, as described herein, the policy controller 125 sends the textual data to one or both of the device TTS 127 and the remote TTS 130 and receives speech data corresponding to the textual data from one or both of the device TTS 127 and the remote TTS 130.

In operation 511, the cache 123 is updated to store the input textual data and the corresponding speech data, i.e., the corresponding output, generated by the one or more of the device TTS 127 and the remote TTS 130. According to various embodiments described herein, the input textual data and corresponding output are stored in the cache 123 for a particular period of time, until replaced by another input and corresponding output, or pinned in the cache 123 to be stored until manually removed or replaced.

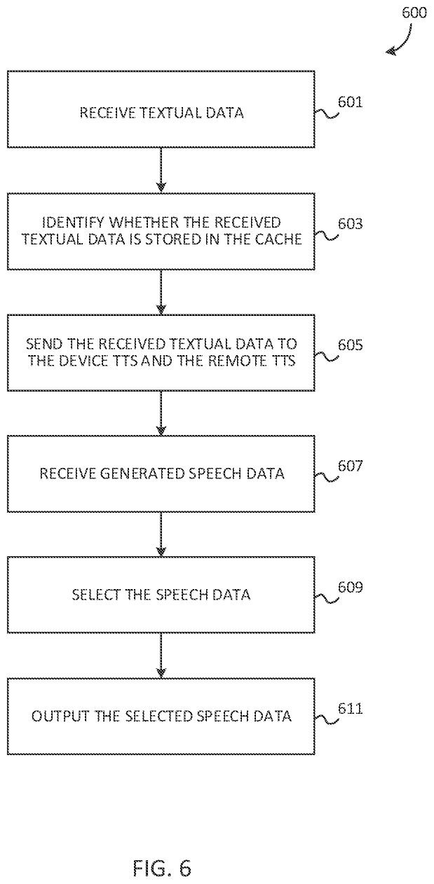

FIG. 6 is a flowchart illustrating a computerized method for a hybrid TTS according to an embodiment. The method 600 illustrated in FIG. 6 is for illustration only. Other examples of the method 600 can be used without departing from the scope of the present disclosure. The method 600 can be implemented by one or more components of the system 100 illustrated in FIG. 1, such as the components of the computing apparatus 718 described in greater detail below in the description of FIG. 7.

In operation 601, the unified TTS interface 121 receives textual data. The textual data is received from the user application 110. In some embodiments, the textual data is generated by the response identifying module 213, described above in reference to FIG. 2.

In operation 603, the unified TTS interface 121 identifies whether the received textual data is stored in the cache 123. For example, to identify the received textual data is stored in the cache, the unified TTS interface 121 identifies whether the textual data matches a keyword stored in the cache 123 and identifies speech data corresponding to the received textual data identified in the cache 123. As described above in reference to FIG. 5, based on the unified TTS interface 121 identifying the received textual data in the cache 123, the unified TTS interface 121 returns the corresponding output, which includes speech data corresponding to the received textual data. Based on the unified TTS interface 121 not identifying the received textual data as in the cache 123 (e.g., the received textual data is omitted or missing from the cache 123), the unified TTS interface 121 sends the textual data to the policy controller 125.

In operation 605, based on the textual data not being identified in the cache 123 by the unified TTS interface 121, the policy controller 125 sends the received textual data to one or both of the device TTS 127 and the remote TTS 130. The policy controller 125 determines to send the textual data to one or both of the device TTS 127 and the remote TTS 130 based on the transmission policy or other policy. In some embodiments, the policy controller 125 sends the textual data to both the device TTS 127 and the remote TTS 130 such that both the device TTS 127 and the remote TTS 130 generates speech data corresponding to the textual data.

In operation 607, the policy controller 125 receives the speech data generated by the device TTS 127 and/or the remote TTS 130. In embodiments where the textual data is sent to only one of the device TTS 127 and the remote TTS 130, the policy controller 125 receives the speech data only from the TTS service to which the textual data was sent. In embodiments where the textual data is sent to both the device TTS 127 and the remote TTS 130, the policy controller 125 expects to receive the speech data from both the device TTS 127 and the remote TTS 130. However, in some instances, speech data from a TTS service is expected, but not received. For example, textual data is sent to the remote TTS 130 via a network connection, but not received due to the network connection timing out or being dropped.

In operation 609, the policy controller 125 selects the speech data received from the device TTS 127 and the remote TTS 130 based on a selection policy or other policy, and sends the selected speech data to the user application 110. The selected speech data is an audio version of the received textual data. As described herein, the selection policy includes one or more of cognition-driven policies, performance-driven policies, and quality-driven policies that drive the policy controller 125 to select generated speech data from the device TTS 127, the remote TTS 130, or to combine aspects of the generated speech data from the device TTS 127 with aspects of the generated speech data from the remote TTS 130 into comprehensive speech data. In some embodiments, the transmission policy depends, at least in part, on the selection policy.

In operation 611, the user application 110 outputs the selected speech data. For example, the user application 110 controls an output device, such as the output device 217, to output the speech data as the output 219 to the user 201.

### Exemplary Operating Environment

The present disclosure is operable with a computing apparatus according to an embodiment as a functional block diagram 700 in FIG. 7. In an embodiment, components of a computing apparatus 718 may be implemented as a part of an electronic device according to one or more embodiments described in this specification. The computing apparatus 718 comprises one or more processors 719 which may be microprocessors, controllers, or any other suitable type of processors for processing computer executable instructions to control the operation of the electronic device. Alternatively, or in addition, the processor 719 is any technology capable of executing logic or instructions, such as a hardcoded machine. Platform software comprising an operating system 720 or any other suitable platform software may be provided on the apparatus 718 to enable application software 721 to be executed on the device.

Computer executable instructions may be provided using any computer-readable media that are accessible by the computing apparatus 718. Computer-readable media may include, for example, computer storage media such as a memory 722 and communications media. Computer storage media, such as a memory 722, include volatile and non-volatile, removable, and non-removable media implemented in any method or technology for storage of information such as computer readable instructions, data structures, program modules or the like. Computer storage media include, but are not limited to, RAM, ROM, EPROM, EEPROM, persistent memory, phase change memory, flash memory or other memory technology, CD-ROM, digital versatile disks (DVD) or other optical storage, magnetic cassettes, magnetic tape, magnetic disk storage, shingled disk storage or other magnetic storage devices, or any other non-transmission medium that can be used to store information for access by a computing apparatus. In contrast, communication media may embody computer readable instructions, data structures, program modules, or the like in a modulated data signal, such as a carrier wave, or other transport mechanism. As defined herein, computer storage media do not include communication media. Therefore, a computer storage medium should not be interpreted to be a propagating signal per se. Propagated signals per se are not examples of computer storage media. Although the computer storage medium (the memory 722) is shown within the computing apparatus 718, it will be appreciated by a person skilled in the art, that the storage may be distributed or located remotely and accessed via a network or other communication link (e.g. using a communication interface 723).

The computing apparatus 718 may comprise an input/output controller 724 configured to output information to one or more output devices 725, for example a display or a speaker, which may be separate from or integral to the electronic device. The input/output controller 724 may also be configured to receive and process an input from one or more input devices 726, for example, a keyboard, a microphone, or a touchpad. In one embodiment, the output device 725 may also act as the input device. An example of such a device may be a touch sensitive display. The input/output controller 724 may also output data to devices other than the output device, e.g. a locally connected printing device. In some embodiments, a user may provide input to the input device(s) 726 and/or receive output from the output device(s) 725.

The functionality described herein can be performed, at least in part, by one or more hardware logic components. According to an embodiment, the computing apparatus 718 is configured by the program code when executed by the processor 719 to execute the embodiments of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Program-specific Standard Products (ASSPs), System-on-a-chip systems (SOCs), Complex Programmable Logic Devices (CPLDs), Graphics Processing Units (GPUs).

At least a portion of the functionality of the various elements in the figures may be performed by other elements in the figures, or an entity (e.g., processor, web service, server, application program, computing device, etc.) not shown in the figures.

Although described in connection with an exemplary computing system environment, examples of the disclosure are capable of implementation with numerous other general purpose or special purpose computing system environments, configurations, or devices.

Examples of well-known computing systems, environments, and/or configurations that may be suitable for use with aspects of the disclosure include, but are not limited to, mobile or portable computing devices (e.g., smartphones), personal computers, server computers, hand-held (e.g., tablet) or laptop devices, multiprocessor systems, gaming consoles or controllers, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. In general, the disclosure is operable with any device with processing capability such that it can execute instructions such as those described herein. Such systems or devices may accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions or the specific components or modules illustrated in the figures and described herein. Other examples of the disclosure may include different computer-executable instructions or components having more or less functionality than illustrated and described herein.

In examples involving a general-purpose computer, aspects of the disclosure transform the general-purpose computer into a special-purpose computing device when configured to execute the instructions described herein.

An example system for a hybrid TTS system comprises at least one processor and at least one memory. The memory comprises a cache and computer program code. The at least one memory and the computer program code are configured to, with the at least one processor, cause the at least one processor to receive textual data from a user application; determine that the received textual data is not stored in the cache; send the received textual data to both a remote text to speech (TTS) engine (e.g., service) and to a TTS engine (e.g., service) in the device; receive speech data from both the remote TTS engine and the TTS engine in the device; select, based on a selection policy, the speech data from the remote TTS engine, the TTS engine in the device, or both; and transmit the selected speech data to the user application.

An example computerized method for a hybrid TTS system includes receiving textual data from a user application; determine that the received textual data is not stored in a cache; sending the received textual data to a remote TTS engine and a TTS engine in a device, receiving speech data from both the remote TTS engine and the TTS engine in the device; selecting, based on a selection policy, the speech data from the remote TTS engine, the TTS engine in the device, or both, and transmitting the selected speech data to a user application.

Example one or more computer storage media have computer-executable instructions for a hybrid TTS system that, upon execution by a processor, cause the processor to at least receive textual data from a user application; determine that the received textual data is not stored in a cache; send the received textual data to both a remote TTS engine and to a TTS engine in the device, receive speech data from both the remote TTS engine and to a TTS engine in the device; select, based on a selection policy, the speech data from the remote TTS engine, the TTS engine in the device, or both, and transmit the selected speech data to the user application.

Alternatively, or in addition to the other examples described herein, examples include any combination of the following:
wherein the selection policy includes rules to prioritize at least one of a cognition driven policy, a performance driven policy, or a quality driven policy;
wherein the selection policy is at least one of a reactive selection policy or a proactive selection policy;
select, based on the selection policy, the speech data generated from both the remote TTS engine and the TTS engine in the device;
combine the selected speech data into comprehensive speech data, wherein the comprehensive speech data includes at least a portion of the speech data generated from the remote TTS engine and at least a portion of the speech data generated from the TTS engine in the device;
transmit the comprehensive speech data;
determine to send the received textual data to the remote TTS engine and the TTS engine in the device based on a transmission policy;
wherein the transmission policy is based at least in part on the selection policy;
wherein the remote TTS engine is a TTS engine executed and stored in a cloud
wherein the selected speech data is an audio version of the received textual data;
wherein, to determine whether the received textual data is stored in the cache, the at least one processor is further configured to identify whether the received textual data matches a keyword stored in the cache;
wherein the at least one processor is further configured to, in response to identifying the received textual data is stored in the cache, identify corresponding speech data to the received textual data identified in the cache;
bypass the remote TTS engine and the TTS engine in the device; and
transmit the corresponding speech data to the user application.

While no personally identifiable information is tracked by aspects of the disclosure, examples have been described with reference to data monitored and/or collected from the users. In some examples, notice may be provided to the users of the collection of the data (e.g., via a dialog box or preference setting) and users are given the opportunity to give or deny consent for the monitoring and/or collection. The consent may take the form of opt-in consent or opt-out consent.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The term “comprising” is used in this specification to mean including the feature(s) or act(s) followed thereafter, without excluding the presence of one or more additional features or acts.

In some examples, the operations illustrated in the figures may be implemented as software instructions encoded on a computer readable medium, in hardware programmed or designed to perform the operations, or both. For example, aspects of the disclosure may be implemented as a system on a chip or other circuitry including a plurality of interconnected, electrically conductive elements.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of.” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

1-15. (canceled)

16. A device comprising:
a processor; and
a memory comprising a cache and computer program code, the memory and the computer program code configured to, with the processor, cause the processor to:
receive textual data from a user application;
determine that the received textual data is missing from the cache;
send the received textual data to both a remote text to speech (TTS) engine and to a TTS engine in the device;
receive speech data from both the remote TTS engine and the TTS engine in the device, the received speech data corresponding to the received textual data;
select, based on a selection policy, the received speech data from the remote TTS engine, the TTS engine in the device, or both; and
transmit the selected speech data to the user application.

17. The device of claim 16, wherein the selection policy includes rules to prioritize at least one of a cognition-driven policy, a performance-driven policy, or a quality-driven policy.

18. The device of claim 16, wherein the selection policy is a reactive selection policy or a proactive selection policy.

19. The device of claim 16, wherein the processor is further configured to:
select, based on the selection policy, the speech data generated from both the remote TTS engine and the TTS engine in the device;
combine the selected speech data into comprehensive speech data, wherein the comprehensive speech data includes at least a portion of the speech data generated from the remote TTS engine and at least a portion of the speech data generated from the TTS engine in the device; and
transmit the comprehensive speech data.

20. The device of claim 16, wherein the processor is further configured to:
determine to send the received textual data to the remote TTS engine and the TTS engine in the device based on a transmission policy, and
wherein the transmission policy is based at least in part on the selection policy.

21. The device of claim 20, wherein the remote TTS engine is a TTS engine executed and stored in a cloud.

22. The device of claim 16, wherein the selected speech data is an audio version of the received textual data.

23. The device of claim 16, wherein, to determine whether the received textual data is stored in the cache, the processor is further configured to identify whether the received textual data matches a keyword stored in the cache.

24. The device of claim 23, wherein the processor is further configured to, in response to identifying the received textual data is stored in the cache:
identify corresponding speech data to the received textual data identified in the cache; and
bypass the remote TTS engine and the TTS engine in the device and transmit the corresponding speech data to the user application.

25. A computer-implemented method comprising:
receiving textual data from a user application;
determining that the received textual data is missing from a cache;
sending the received textual data to a remote text to speech (TTS) engine and a TTS engine in a device,
receiving speech data from both the remote TTS engine and the TTS engine in the device, the received speech data corresponding to the received textual data;
selecting, based on a selection policy, the received speech data from the remote TTS engine, the TTS engine in the device, or both, and
transmitting the selected speech data to a user application.

26. The computer-implemented method of claim 25, wherein the selection policy includes rules to prioritize at least one of a cognition-driven policy, a performance-driven policy, or a quality-driven policy.

27. The computer-implemented method of claim 25, wherein the selection policy is a reactive selection policy or a proactive selection policy.

28. The computer-implemented method of claim 25, further comprising:
selecting, based on the selection policy, the speech data generated from both the remote TTS engine and the TTS engine in the device;
combining the selected speech data into comprehensive speech data, wherein the comprehensive speech data includes at least a portion of the speech data generated from the remote TTS engine and at least a portion of the speech data generated from the TTS engine in the device; and
transmitting the comprehensive speech data.

29. The computer-implemented method of claim 25, further comprising:
determining to send the received textual data to the remote TTS engine and the TTS engine in the device based on a transmission policy, and
wherein the transmission policy is based at least in part on the selection policy.

30. The computer-implemented method of claim 29, wherein the remote TTS engine is a TTS engine executed and stored in a cloud.

31. The computer-implemented method of claim 25, wherein the selected speech data is an audio version of the received textual data.

32. The computer-implemented method of claim 25, wherein, to determine whether the received textual data is stored in the cache, the computer-implemented method further comprises:
identifying whether the received textual data matches a keyword stored in the cache.

33. The computer-implemented method of claim 25, further comprising, in response to identifying the received textual data is stored in the cache:
identifying corresponding speech data to the received textual data identified in the cache; and
bypassing the remote TTS engine and the TTS engine in the device and transmitting the corresponding speech data to the user application.

34. A computer storage medium comprising a plurality of instructions that, when executed by a processor, cause the processor to:
receive textual data from a user application;
determine that the received textual data is missing from a cache;
send the received textual data to a remote text to speech (TTS) engine and to a TTS engine in a device;
receive speech data from both the remote TTS engine and the TTS engine in the device, the received speech data corresponding to the received textual data;
select, based on a selection policy, the received speech data from the remote TTS engine, the TTS engine in the device, or both; and
transmit the selected speech data to the user application.

35. The computer storage medium of claim 34, wherein:
the selection policy includes rules to prioritize at least one of a cognition-driven policy, a performance-driven policy, or a quality-driven policy,
the rules are selected by a user, and
the selection policy is a reactive selection policy or a proactive selection policy.
